(19) United States
(12) Patent Application Publication
(10) Pub. No.: US 2024/0012148 A1
(43) Pub. Date: Jan. 11, 2024

(54) OPTICAL SENSING DEVICE, OPTICAL SENSING SYSTEM, AND OPTICAL SENSING METHOD

(71) Applicant: NEC Corporation, Tokyo (JP)

(72) Inventor: Tsubasa NAKAMURA, Tokyo (JP)

(73) Assignee: NEC Corporation, Tokyo (JP)

(21) Appl. No.: 18/215,424

(22) Filed: Jun. 28, 2023

(30) Foreign Application Priority Data
Jul. 6, 2022 (JP) 2022-109031

(51) Int. Cl. G01S 17/89; G01S 7/481

(52) U.S. Cl. CPC G01S 17/89; G01S 7/4817

(57) ABSTRACT

An optical sensing device includes a controller that rotates a light irradiation circuit that irradiates an irradiation target being at least a part of a target with laser light, and thus move an incident position of the laser light on the irradiation target in a reciprocating manner between one end and another end of the irradiation target, via a center positioned between the one end and the another end of the irradiation target, an acquisition circuit that acquires information relating to reflected light associated with the incident position, based on the reflected light from the irradiation target, and a generation circuit that generates point cloud data relating to the irradiation target, based on the information relating to the reflected light, wherein, when the incident position moves to the center of the irradiation target, the controller reduces a speed at which the light irradiation circuit is rotated.

This application is based upon and claims the benefit of priority from Japanese Patent Application No. 2022-109031, filed on Jul. 6, 2022, the disclosure of which is incorporated herein in its entirety by reference.

### TECHNICAL FIELD

The present disclosure relates to an optical sensing device and the like relating to light detection and ranging (LiDAR), for example.

### BACKGROUND ART

In general, when an optical sensing device using a LiDAR technique (hereinafter, also referred to as a “LiDAR device”) is used for acquiring point cloud data relating to an elongated object (for example, a track of a railway line), the LiDAR device is installed on one side of the elongated object. Further, a sight line direction of laser light being output from the LiDAR device is rotated along a longitudinal direction of the elongated object. Thereby, the elongated object is irradiated with the laser light in such a way that the elongated object is subjected to scanning.

The LiDAR device emits the laser light at a constant time interval. Thus, when the sight line direction of the laser light being output from the LiDAR device is rotated as described above, a distance between two points adjacent to each other in point cloud data (hereinafter, referred to as a “point interval” or “point cloud density”) differs according to a rotation speed of the sight line direction of the laser light (that is, an angular speed).

Hereinafter, a range to be subjected to scanning performed by the LiDAR device is referred to as a “scanning range”. Further, a method of setting a predetermined angle range to the scanning range by reciprocally rotating the sight line direction of the laser light within the predetermined angle range of less than 360 degrees (typically, less than 180 degrees) is referred to as a “reciprocative scanning method”.

Herein, in a case of the LiDAR device adopting the reciprocative scanning method, since the sight line direction of the laser light is reciprocally rotated, an angular speed at a center portion of the scanning range is higher than an angular speed at both end portions of the scanning range.

PTL 1 discloses a light source device capable of controlling a light deflector appropriately at high accuracy in such a way that a scanning speed of laser light is relatively gentle within a predetermined scanning range even when a heavy scanning means such as a high reflectance mirror is used as a scanning means for scanning a wavelength conversion member with light, and discloses a light projection device using the light source device.

Further, PTLs 2 to 4 also disclose techniques relating to the present disclosure.
[PTL 1] International Patent Publication WO2018/163885
[PTL 2] Japanese Unexamined Patent Application Publication No. 2020-067405
[PTL 3] Japanese Unexamined Patent Application Publication (Translation of PCT Application) No. 2002-500762
[PTL 4] Japanese Unexamined Patent Application Publication No. 2013-190272

### SUMMARY

As described above, an angular speed is higher at both the end portions than at the center portion of the scanning range, and hence the LiDAR device adopting the reciprocative scanning method has a problem that point cloud density varies at a time of generating point cloud data.

Further, a technique of controlling a light amount of a head lamp is disclosed as the technique described in PTL 1, and variation of an angular speed that is caused by a principle of the reciprocative scanning method is not considered. Further, as the technique described in PTL 1, there is no disclosure relating to a technique of controlling point cloud density of point cloud data by controlling a rotation speed in the above-mentioned reciprocative scanning method. In other words, there is a problem that the technique in PTL 1 cannot suppress variation of point cloud density that is caused by the principle of the reciprocative scanning method.

The present disclosure has been made in view of the above-mentioned problem, and an exemplary object of the disclosure is to provide suppression of variation of point cloud density that is caused by the principle of the reciprocative scanning method.

An optical sensing device according to the present disclosure includes:
a control means for rotating a light irradiation means for irradiating an irradiation target being at least a part of a target with laser light, and thus moving an incident position of the laser light on the irradiation target in a reciprocating manner between one end portion and another end portion of the irradiation target, via a center portion positioned between the one end portion and the another end portion of the irradiation target;
an acquisition means for acquiring information relating to reflected light associated with the incident position, based on the reflected light of the laser light from the irradiation target; and
a generation means for generating point cloud data relating to the irradiation target, based on the information relating to the reflected light, wherein,
when the incident position moves from the one end portion or the another end portion to the center portion of the irradiation target, the control means reduces a speed at which the light irradiation means is rotated.

An optical sensing method according to the present disclosure includes:
rotating a light irradiation means for irradiating an irradiation target being at least a part of a target with laser light, and thus moving an incident position of the laser light on the irradiation target in a reciprocating manner between one end portion and another end portion of the irradiation target, via a center portion positioned between the one end portion and the another end portion of the irradiation target;
reducing a speed at which the light irradiation means is rotated when the incident position moves from the one end portion or the another end portion to the center portion of the irradiation target;
acquiring information relating to reflected light associated with the incident position, based on the reflected light of the laser light from the irradiation target; and
generating point cloud data relating to the irradiation target, based on the information relating to the reflected light.

An optical sensing system according to the present disclosure includes:
a control means for rotating a light irradiation means for irradiating an irradiation target being at least a part of a target with laser light, and thus moving an incident position of the laser light on the irradiation target in a reciprocating manner between one end portion and another end portion of the irradiation target, via a center portion positioned between the one end portion and the another end portion of the irradiation target;
an acquisition means for acquiring information relating to reflected light associated with the incident position, based on the reflected light of the laser light from the irradiation target; and
a generation means for generating point cloud data relating to the irradiation target, based on the information relating to the reflected light, wherein,
when the incident position moves from the one end portion or the another end portion to the center portion of the irradiation target, the control means reduces a speed at which the light irradiation means is rotated.

According to the present disclosure, it is possible to suppress variation of point cloud density that is caused by the principle of the reciprocative scanning method.

### BRIEF DESCRIPTION OF THE DRAWINGS

Exemplary features and advantages of the present disclosure will become apparent from the following detailed description when taken with the accompanying drawings in which:

FIG. 1 is an exemplary block diagram illustrating a configuration of an optical sensing system of the first example embodiment of the present disclosure;

FIG. 2 is a diagram illustrating details of the optical sensing system of the first example embodiment of the present disclosure;

FIG. 3 is a diagram illustrating details of the optical sensing system of the first example embodiment of the present disclosure;

FIG. 4 is a diagram illustrating details of the optical sensing system of the first example embodiment of the present disclosure;

FIG. 5 is a flowchart illustrating an operation example of the optical sensing system of the first example embodiment of the present disclosure;

FIG. 6 is an exemplary block diagram illustrating a configuration of an optical sensing system of the second example embodiment of the present disclosure;

FIG. 7 is a flowchart illustrating an operation example of the optical sensing system of the second example embodiment of the present disclosure; and

FIG. 8 is a diagram illustrating an example of an information processing device for achieving the optical sensing systems and the like according to the first and the second example embodiments of the present disclosure.

### EXAMPLE EMBODIMENT

Next, a detailed explanation will be given for a first example embodiment with reference to the drawings.

### First Example Embodiment

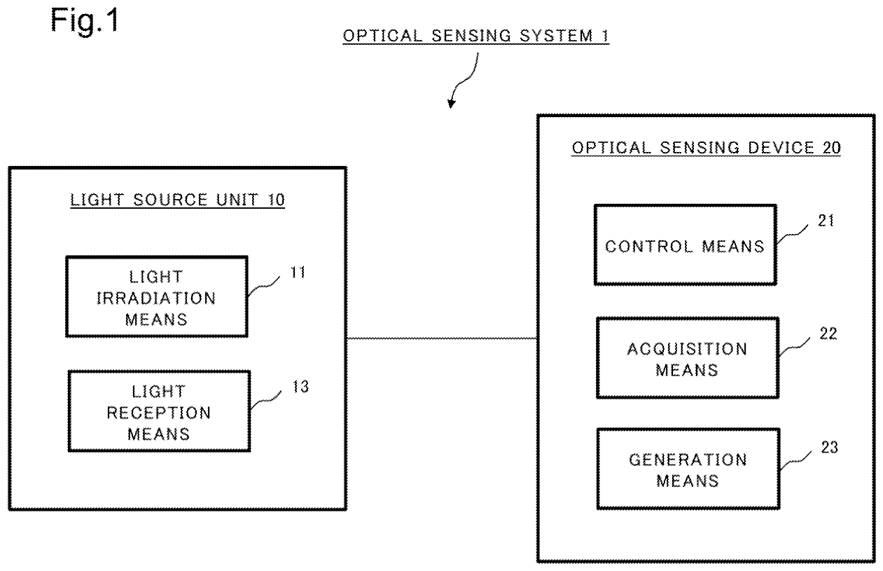

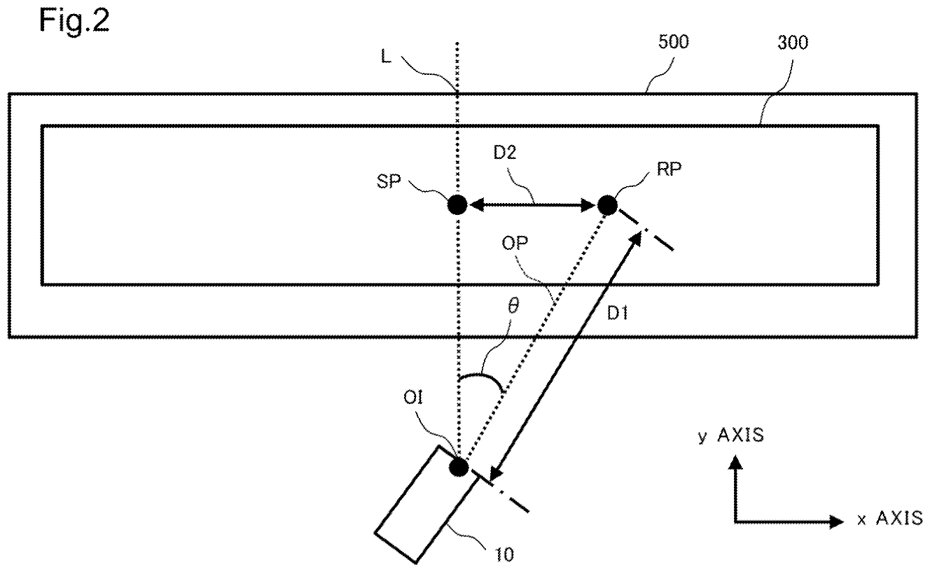

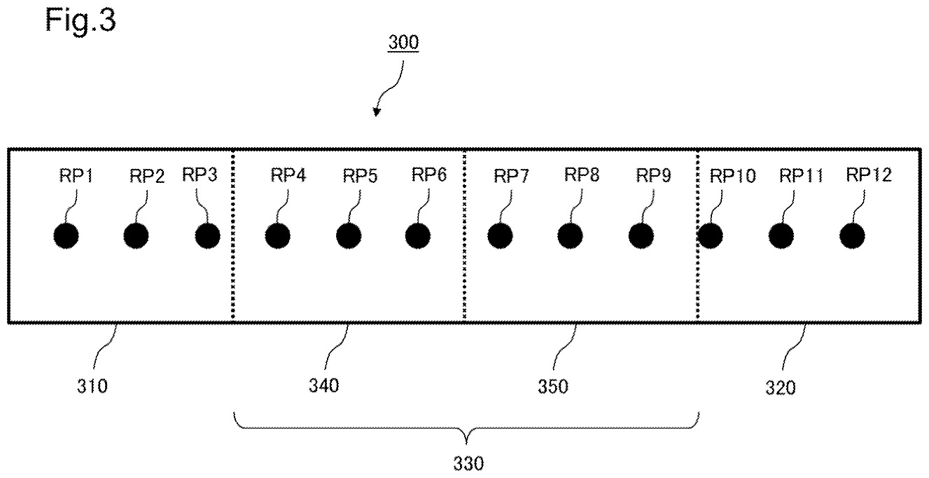

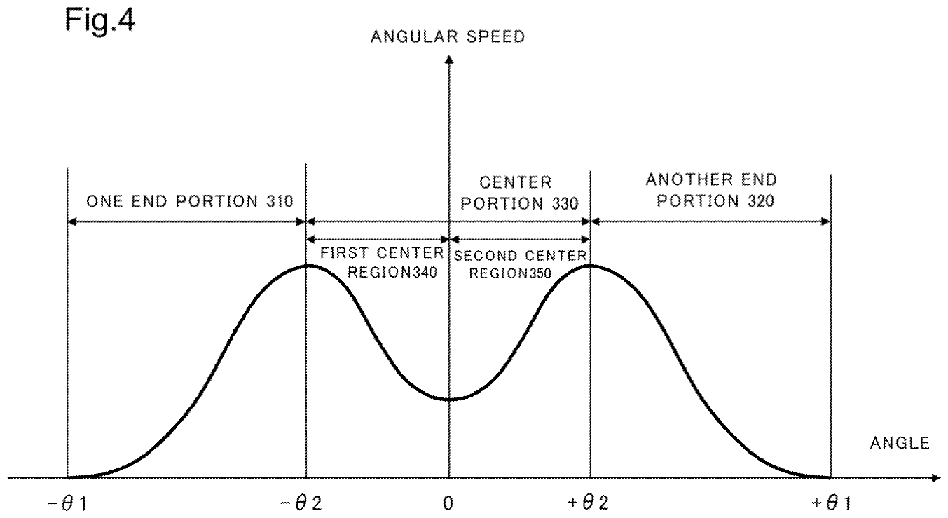

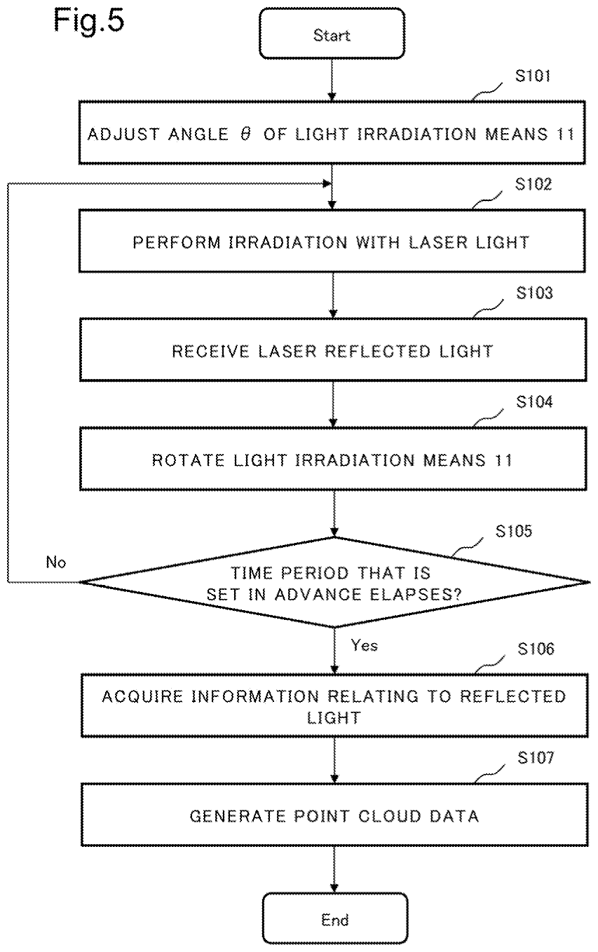

An optical sensing system 1 of a first example embodiment is described with reference to FIG. 1, FIG. 2, FIG. 3, FIG. 4, and FIG. 5. FIG. 1 is an exemplary block diagram illustrating a configuration of the optical sensing system 1. FIG. 2, FIG. 3, and FIG. 4 are diagrams for describing details of the optical sensing system 1. FIG. 5 is a flowchart for describing an operation example of the optical sensing system 1.

A configuration of the optical sensing system 1 is described. As illustrated in FIG. 1, the optical sensing system 1 includes a light source unit 10 and an optical sensing device 20. In FIG. 1, the light source unit and the optical sensing device 20 are provided separately, but may be integrated with each other. The light source unit 10 and the optical sensing device 20 are mutually communicable.

The light source unit 10 includes a light irradiation means 11 and a light reception means 13.

The light irradiation means 11 irradiates an irradiation target 300 being at least a part of a target 500, with laser light. In other words, the irradiation target 300 is a part or an entirety of the target 500, and is a range irradiated with the laser light by the light irradiation means 11. Further, the laser light is pulsed laser light. Further, the irradiation target 300 is provided to a location associated with a scanning range of the light irradiation means 11. In other words, the light irradiation means 11 is arranged at a location where a part or an entirety of the target 500 can be irradiated with the laser light. For example, as illustrated in FIG. 2, the light irradiation means 11 performs irradiation with the laser light from a light input/output end OI provided to the light source unit 10. With this, the irradiation laser light is propagated along an optical path OP, and is incident at a position on the irradiation target 300. Hereinafter, a position at which the laser light is incident is also referred to as a reflection point RP or an incident position. The optical path OP is a line section that connects the light input/output end OI and the reflection point RP to each other. Here, the target indicates an elongated such as a railway line and a road lane.

Further, the light reception means 13 receives the laser light reflected at the incident position on the irradiation target 300. Hereinafter, “the laser light reflected at the irradiation target 300” is regarded as “laser reflected light”. For example, in the example of FIG. 2, the light reception means 13 receives the laser reflected light from the reflection point RP on the irradiation target 300 via the optical path OP and the light input/output end OI. Further, the light reception means 13 is capable of acquiring laser reflected light from different reflection points RP by rotating the light irradiation means 11 that irradiates the irradiation target 300 with the laser light, as described later.

Next, the optical sensing device 20 is described. The optical sensing device 20 includes a control means 21, an acquisition means 22, and a generation means 23. The control means 21, the acquisition means 22, and the generation means 23 may be provided in one device, or may be provided in different devices.

The control means 21 rotates the light irradiation means 11 that irradiates the irradiation target 300 with the laser light. In other words, while being rotated by the control means 21, the light irradiation means 11 irradiates the irradiation target 300 with the pulsed laser light at a predetermined cycle (for example, one second). With this, the laser light is reflected at a plurality of positions on the irradiation target 300. Further, the acquisition means 22 acquires information relating to the reflected light associated with the plurality of positions on the irradiation target 300, based on the reflected light of the laser light.

Here, with reference to FIG. 2, information relating to the reflected light is described. FIG. 2 illustrates a positional relationship between the light source unit 10 and the irradiation target 300 on a plane including an x axis and a y axis. The x axis and the y axis are set on a plane (horizontal plane) vertical to a vertical direction (z axis), for example.

The light irradiation means 11 is rotated by the control means 21, and thus is capable of performing irradiation with the laser light at a freely selected angle θ. For example, as illustrated in FIG. 2, the angle θ is an angle formed between a reference line L set on the xy plane and the optical path OP. In the example illustrated in FIG. 2, the reference line L is a linear line that extends from the light source unit 10 to the irradiation target 300. The control means 21 is capable of detecting the angle θ with a gyro sensor, which is omitted in illustration. The angle θ at which the light irradiation means 11 is rotated is set in advance in such a way that the laser light emitted from the light irradiation means 11 is incident on the irradiation target 300.

The acquisition means 22 acquires the length of the optical path OP, based on a time period from timing at which the light irradiation means 11 performs irradiation with the laser light to timing at which the light reception means 13 receives the laser reflected light. Hereinafter, “the time period to the timing at which the light reception means 13 receives the laser reflected light” is referred to as a “time period t”. Specifically, the length of the optical path OP is acquired by dividing a value, which is a product of the time period t and the speed of light, by two. The acquisition means 22 calculates a length of a line section D1 of the optical path OP projected on the xy plane by multiplying the length of the optical path OP by sin γ. Here, y is an angle formed between the z axis and the optical path OP.

The acquisition means 22 acquires a difference between an x coordinate of the light input/output end OI and an x coordinate of the reflection point RP (D2 in FIG. 4) by multiplying the length of the line section D1 by sin θ. With this, the acquisition means 22 stores a relative position of the reflection point RP in association with the angle θ. Further, the acquisition means 22 may store an absolute position of a reference point SP on the reference line L in advance. In this case, with this, the acquisition means 22 may acquire an absolute position of the reflection point RP from the relative position of the reflection point RP and the absolute position of the reference point SP, and store the absolute position in association with the angle θ.

The information relating to the reflected light described above may be position information relating to the relative position and the absolute position. Further, the information relating to the reflected light may be information relating to intensity of the reflected light. As described above, the control means 21 rotates the light irradiation means 11 in such a way to change the angle θ, and thus the laser light is incident at the reflection points RP at the different positions. The light irradiation means 11 performs irradiation with the laser light at a constant time interval, and thus the reflection laser light from the plurality of reflection points RP on the irradiation target 300 is received. With this, the acquisition means 22 is capable of acquiring the relative position or the absolute position for each of the plurality of reflection points RP on the irradiation target 300. In this manner, the acquisition means 22 acquires the information relating to the reflected light associated with the plurality of positions on the irradiation target 300, based on the reflected light of the laser light.

The acquisition means 22 may further acquire intensity of the reflected light associated with the plurality of positions on the irradiation target 300, from the light reception means 13. When the irradiation target 300 is a railway line, the light easily scatters at a damaged part, and hence intensity of the reflection laser light from the damaged part is low. Thus, when intensity is lower than a threshold value at a position, the acquisition means 22 may specify the position as a damaged part.

Next, with reference to FIG. 3 and FIG. 4, details of the control means 21 are described. FIG. 3 is a diagram illustrating details of the irradiation target 300. As illustrated in FIG. 3, the irradiation target 300 includes one end portion 310, another end portion 320, and a center portion 330. The center portion 330 of the irradiation target 300 includes a first center region 340 and a second center region 350. The center portion 330 is positioned between the one end portion 310 and the another end portion 320.

As described above, the control means 21 rotates the light irradiation means 11 that irradiates the target with the laser light. With this, the control means 21 moves the incident position of the laser light from the one end portion 310 to the another end portion 320 via the center portion 330 positioned between the one end portion 310 and the another end portion 320 of the irradiation target 300. By repeating this movement, the control means 21 moves the incident position of the laser light on the irradiation target 300 in a reciprocating manner between the one end portion 310 and the another end portion 320 of the irradiation target 300. For example, in the example illustrated in FIG. 3, when the light irradiation means 11 performs irradiation with the laser light from the one end portion 310, the laser light is incident at the reflection point RP1 to the reflection point RP13. Then, the light irradiation means 11 moves the incident position of the laser light from the another end portion 320 to the one end portion 310 via the center portion 330. Subsequently, in the example illustrated in FIG. 3, the light irradiation means 11 causes the laser light to be incident at the reflection point RP13 to the reflection point RP1. In this manner, the control means 21 rotates the light irradiation means 11 in such a way that the incident position of the laser light moves along a longitudinal direction of the target 500 or the irradiation target 300.

Next, with reference to FIG. 4, a speed at which the control means 21 rotates the light irradiation means 11 is described. The graph described in FIG. 4 shows a relationship between a rotation speed (also referred to as an “angular speed”) and the angle θ. In the example of FIG. 4, when the angle θ is an angle between −θ2 and +θ2, the light irradiation means 11 emits the laser light to the center portion 330. Further, when the angle θ is between −θ1 and −θ2, the light irradiation means 11 emits the laser light to the one end portion 310. Further, when the angle θ is an angle between +θ2 and +θ1, the light irradiation means 11 emits the laser light to the another end portion 320.

It is assumed that each of the center portion 330, the one end portion 310, and the another end portion 320 and the angle θ are associated with each other in advance. For example, when an X coordinate of a center point of the irradiation target 300 being the scanning range is 0, and X coordinates of end points of the scanning range are −L/2 and +L/2, a range that satisfies a condition |X|<α× L/2 for a predetermined coefficient α is set as the “center portion”. Here, for example, the coefficient α is set to a value falling within a range a={0.1, 0.75}. An association relationship between each of the center portion 330, the one end portion 310, and the another end portion 320 and the angle θ may be set by other methods. In this description, the center point indicates the reference point SP.

Further, for example, when the light irradiation means 11 is rotated from an angle of 0 to an angle of −θ2 or +θ2, the control means 21 continuously increases the angular speed until the angle θ reaches −θ2 or +θ2. Further, when the light irradiation means 11 is rotated from an angle of +θ2 to an angle of +θ1, the control means 21 continuously reduces the angular speed until the angle θ reaches +θ1. In this manner, when the incident position at which the laser light is incident moves from the one end portion 310 or the another end portion 320 to the center portion 330, the control means 21 reduces the speed at which the light irradiation means 11 is rotated.

Further, in the example of FIG. 4, when the incident position at which the laser light is incident moves between the first center region and the second center region, the control means 21 increases the speed at which the light irradiation means 11 is rotated. Specifically, the light irradiation means 11 is rotated in such a way that the angle θ changes from an angle between 0 and −θ2 to an angle between 0 and +θ2, the control means 21 increases the angular speed. Further, when the light irradiation means 11 is rotated in such a way that the angle θ changes from the angle between 0 and +θ2 to the angle between 0 and −θ2, the control means 21 increases the angular speed.

Description is made on a case in which the control means 21 reduces the speed at which the light irradiation means 11 is rotated when the incident position at which the laser light is incident moves from the one end portion 310 or the another end portion 320 to the center portion 330. In the example of FIG. 4, the control means 21 increases the angular speed when the angle θ exceeds 0 after reducing the angular speed, but the timing for the increase is not limited thereto. Further, the control means 21 performs increase and reduction of the speed once for each while the angle θ is changed between −θ2 and +θ2, but may perform increase and reduction of the speed a plurality of times for each.

The generation means 23 generates point cloud data being an aggregate of points associated with incident positions on the irradiation target 300, among the plurality of positions at which the laser light is reflected. For example, the point cloud data indicate a three-dimensional model. The generation means 23 generates a model indicating a shape of the irradiation target 300 by plotting the plurality of reflection points RP on a three-dimensional model, based on the position information of the reflection points RP that is acquired by the acquisition means 22.

Next, with reference to FIG. 5, an optical sensing method of the optical sensing system 1 is described. FIG. 5 is a flowchart illustrating the optical sensing system method.

The control means 21 adjusts the angle θ of the light irradiation means 11 (S101). For example, the control means 21 rotates the light irradiation means 11 in such a way that the angle θ is −θ1.

The light irradiation means 11 of the light source unit 10 performs irradiation with the laser light (S102). With this, the laser light is reflected at the reflection point RP on the irradiation target 300.

The light reception means 13 of the light source unit 10 receives the laser reflected light (S103). As described above, the acquisition means 22 may acquire the absolute position of the reflection point RP from the relative position of the reflection point RP and the absolute position of the reference point SP, and may store the absolute position in association with the angle θ. Further, the acquisition means 22 may further acquire intensity of the reflected light associated with the plurality of positions on the irradiation target 300, from the light reception means 13. In this manner, the acquisition means 22 acquires the information relating to the reflected light associated with the plurality of positions on the irradiation target 300, based on the reflected light of the laser light.

The control means 21 rotates the light irradiation means 11 (S104). In this state, the control means 21 determines the rotation speed with reference to an inclination angle of the light irradiation means 11 (0 in FIG. 2) and a rotation direction of the light irradiation means 11, as illustrated in FIG. 4. When the incident position of the laser light moves from the one end portion 310 or the another end portion 320 to the center portion 330, the control means 21 reduces the speed at which the light irradiation means 11 is rotated.

The control means 21 determines whether a predetermined time period elapses (S105). Specifically, the control means 21 determines whether the predetermined time period elapses from the processing in S101 to the processing in S105. The predetermined time period is 30 minutes or one hour, for example. When the predetermined time period does not elapse, the control means 21 executes the processing in S102. Further, when the predetermined time period elapses, the control means 21 executes the processing in S106.

The acquisition means 22 acquires the information relating to the reflected light (S106). Specifically, the acquisition means 22 acquires the position information relating to the position at which the laser light is reflected among the plurality of positions on the irradiation target 300, based on the reflected light of the laser light.

The generation means 23 generates the point cloud data (S107). Specifically, the generation means 23 generates the point cloud data being an aggregate of the points associated with the positions on the irradiation target 300, among the plurality of positions at which the laser light is reflected.

As described above, the optical sensing system 1 includes the control means 21, the acquisition means 22, and the generation means 23. The control means 21 rotates the light irradiation means 11 that irradiates the irradiation target 300 being at least a part of the target with the laser light, and thus moves the incident position of the laser light on the irradiation target 300 in a reciprocating manner between the one end portion 310 and the another end portion 320 of the irradiation target 300, via the center portion 330 positioned between the one end portion 310 and the another end portion 320 of the irradiation target 300. Further, the acquisition means 22 acquires the information relating to the reflected light associated with the incident position, based on the reflected light of the laser light from the irradiation target 300. Further, the generation means 23 generates the point cloud data relating to the irradiation target, based on the information relating to the reflected light. Further, when the incident position moves from the one end portion 310 or the another end portion 320 to the center portion 330 of the irradiation target 300, the control means 21 reduces the speed at which the light irradiation means 11 is rotated.

In the optical sensing system 1, the speed at which the light irradiation means 11 is rotated is reduced when the incident position of the laser light moves from the one end portion 310 or the another end portion 320 to the center portion 330. Thus, it is possible to suppress the problem of the general LiDAR device adopting the reciprocative scanning method, specifically, variation of point cloud density varies at the time of generating the point cloud data, which is caused because the angular speed at both the end portions is higher than the angular speed at the center portion in the scanning range.

### Second Example Embodiment

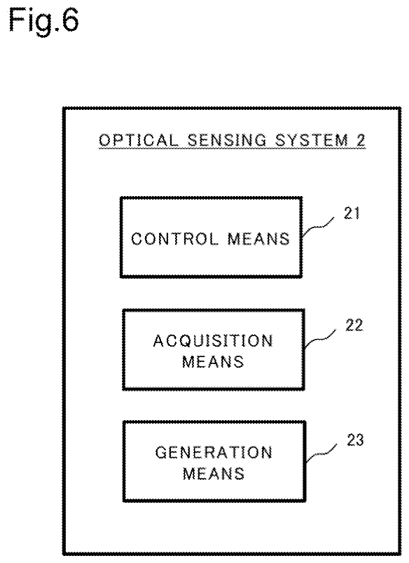

An optical sensing system 2 of the second example embodiment is described with reference to FIG. 6. FIG. 6 is an exemplary block diagram illustrating a configuration of the optical sensing system 2.

A configuration of the optical sensing system 2 is described. As illustrated in FIG. 6, the optical sensing system 2 includes the control means 21, the acquisition means 22, and the generation means 23.

The control means 21 rotates the light irradiation means that irradiates the irradiation target being at least a part of the target with the laser light, and thus moves the incident position of the laser light on the irradiation target in a reciprocating manner between the one end portion and the another end portion of the irradiation target, via the center portion positioned between the one end portion and the another end portion of the irradiation target. Further, the acquisition means 22 acquires the information relating to the reflected light associated with the incident position, based on the reflected light of the laser light from the irradiation target. Further, the generation means 23 generates the point cloud data relating to the target, based on the information relating to the reflected light. Further, when the incident position moves from the one end portion or the another end portion to the center portion of the irradiation target, the control means 21 reduces the speed at which the light irradiation means is rotated.

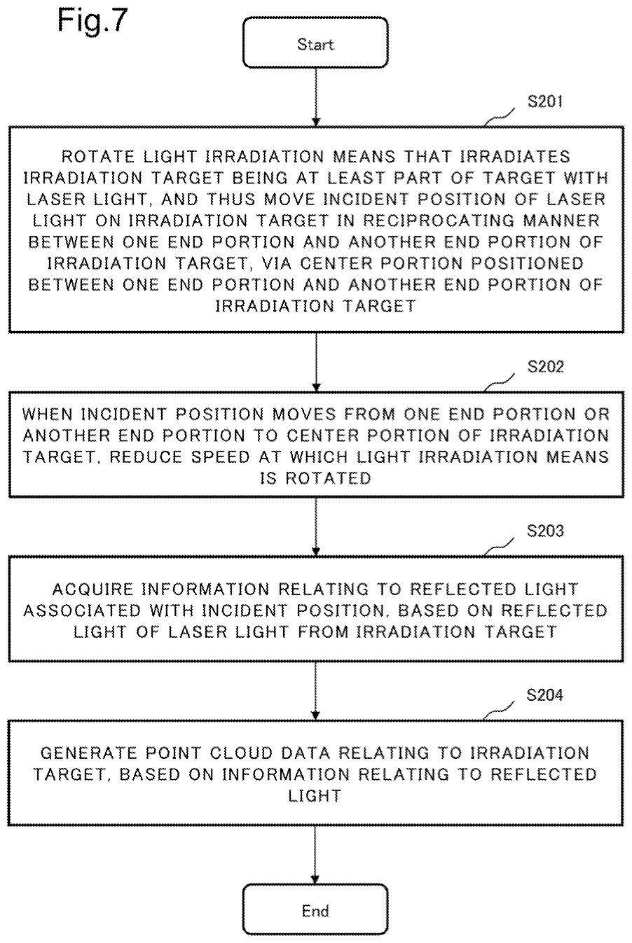

Next, with reference to FIG. 7, an operation of the optical sensing system 2 is described. FIG. 7 is a flowchart illustrating an optical sensing method of the optical sensing system 2. The control means 21 rotates the light irradiation means that irradiates the irradiation target being at least a part of the target with the laser light, and thus moves the incident position of the laser light on the irradiation target in a reciprocating manner between the one end portion and the another end portion of the irradiation target, via the center portion positioned between the one end portion and the another end portion of the irradiation target (S201). When the incident position moves from the one end portion or the another end portion to the center portion of the irradiation target, the control means 21 reduces the speed at which the light irradiation means is rotated (S202). The acquisition means 22 acquires the information relating to the reflected light associated with the incident position, based on the reflected light of the laser light from the irradiation target (S203). The generation means 23 generates the point cloud data relating to the irradiation target, based on the information relating to the reflected light (S204).

As described above, the optical sensing system 2 includes the control means 21, the acquisition means 22, and the generation means 23. The control means 21 rotates the light irradiation means 11 that irradiates the irradiation target being at least a part of the target with the laser light, and thus moves the incident position of the laser light on the irradiation target in a reciprocating manner between the one end portion and the another end portion of the irradiation target, via the center portion positioned between the one end portion and the another end portion of the irradiation target. Further, the acquisition means 22 acquires the information relating to the reflected light associated with the incident position, based on the reflected light of the laser light from the irradiation target. Further, the generation means 23 generates the point cloud data relating to the irradiation target, based on the information relating to the reflected light. Further, when the incident position moves from the one end portion or the another end portion to the center portion of the irradiation target, the control means 21 reduces the speed at which the light irradiation means 11 is rotated.

In the optical sensing system 2, the speed at which the light irradiation means is rotated is reduced when the incident position of the laser light moves from the one end portion or the another end portion to the center portion. Thus, it is possible to suppress the problem of the general LiDAR device adopting the reciprocative scanning method, specifically, variation of point cloud density varies at the time of generating the point cloud data, which is caused because the angular speed at both the end portions is higher than the angular speed at the center portion in the scanning range.

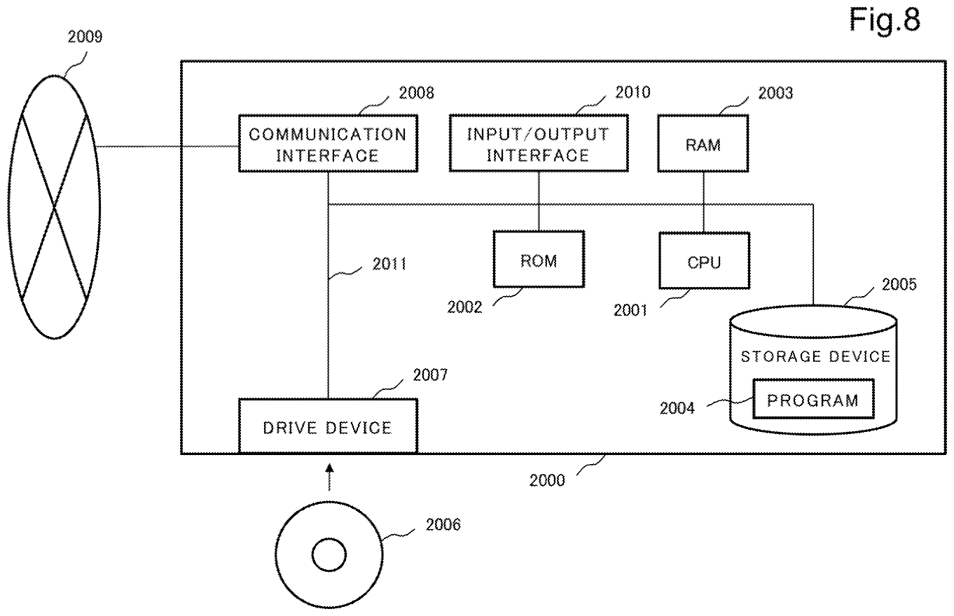

Further, some or all of the components of each of the devices or the system are achieved by any combination of an information processing device 2000 and a program, as illustrated in FIG. 8, for example. FIG. 8 is a diagram illustrating an example of an information processing device for achieving the optical sensing systems 1 and 2, and the like. As an example, the information processing device 2000 includes the following configuration.
A central processing unit (CPU) 2001
A read only memory (ROM) 2002
A random access memory (RAM) 2003
A program 2004 loaded on the RAM 2003
A storage device 2005 that stores the program 2004
A drive device 2007 that performs writing and reading of a recording medium 2006
A communication interface 2008 that is connected to a communication network 2009
An input/output interface 2010 that inputs and outputs data
A bus 2011 that connects each component

Each of the components of each of the devices in each of the example embodiments is achieved by the CPU 2001 acquiring and executing the program 2004 for achieving those functions. For example, the program 2004 for achieving functions of the components of each of the devices is stored in the storage device 2005 or the RAM 2003 in advance, and is read out by the CPU 2001, as required. The program 2004 may be supplied to the CPU 2001 via the communication network 2009, or may be stored in advance in the recording medium 2006, and may be supplied to the CPU 2001 by the drive device 2007 reading out the program.

Various modification examples are given as a method of achieving each of the devices. For example, each of the devices may be achieved by any combinations of a program and the information processing device 2000, each of which is separately provided for each of the components. Further, a plurality of components to be included in each of the devices may be achieved by any one combination of a program and the information processing device 2000.

Further, a part or an entirety of each of the components of each of the devices is achieved by a general or dedicated circuitry including a processor or the like, or by a combination thereof. These may be configured by a single chip or a plurality of chips connected to each other via a bus. A part or an entirety of each of the components of each of the devices may be achieved by a combination of the circuitry or the like described above and a program.

When a part or an entirety of each of the components of each of the devices is achieved by a plurality of information processing devices, circuitries, and the like, the plurality of information processing devices, the circuitries, and the like may be arranged in a centralized way, or may be arranged in a distributed way. For example, the information processing devices, the circuitries, and the like may be achieved in a form in which each of the information processing devices, the circuitries, and the like is connected via a communication network, such as a client-and-server system and a cloud computing system.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed disclosure even if the claims are amended during prosecution.

### REFERENCE SIGNS LIST

1, 2 Optical sensing system
10 Light source unit
11 Light irradiation means
12 Light reception means
20 Optical sensing device
21 Control means
22 Acquisition means
23 Generation means
300 Irradiation target
310 One end portion
320 Another end portion
330 Center portion
340 First center region
350 Second center region

1. An optical sensing device comprising:
a control circuit configured to rotate a light irradiation circuit configured to irradiate an irradiation target being at least a part of a target with laser light, and thus move an incident position of the laser light on the irradiation target in a reciprocating manner between one end portion and another end portion of the irradiation target, via a center portion positioned between the one end portion and the another end portion of the irradiation target;
an acquisition circuit configured to acquire information relating to reflected light associated with the incident position, based on the reflected light of the laser light from the irradiation target; and
a generation circuit configured to generate point cloud data relating to the irradiation target, based on the information relating to the reflected light, wherein,
when the incident position moves from the one end portion or the another end portion to the center portion of the irradiation target, the control circuit reduces a speed at which the light irradiation circuit is rotated.

2. The optical sensing device according to claim 1, wherein
the center portion of the irradiation target includes a first center region and a second center region with a center point of the center portion as a center, and,
when the incident position on which the laser light is incident moves between the first center region and the second center region, the control circuit increases a speed at which the light irradiation circuit is rotated.

3. The optical sensing device according to claim 1, wherein
the light irradiation circuit performs irradiation with the laser light at a constant time interval.

4. The optical sensing device according to claim 1, wherein
the control circuit rotates the light irradiation circuit in such a way that the incident position on which the laser light is incident moves along a longitudinal direction of the target.

5. The optical sensing device according to claim 4, wherein
the target is a railway line.

6. An optical sensing system comprising:
a control circuit configured to rotate a light irradiation circuit configured to irradiate an irradiation target being at least a part of a target with laser light, and thus move an incident position of the laser light on the irradiation target in a reciprocating manner between one end portion and another end portion of the irradiation target, via a center portion positioned between the one end portion and the another end portion of the irradiation target;
an acquisition circuit configured to acquire information relating to reflected light associated with the incident position, based on the reflected light of the laser light from the irradiation target; and
a generation circuit configured to generate point cloud data relating to the irradiation target, based on the information relating to the reflected light, wherein,
when the incident position moves from the one end portion or the another end portion to the center portion of the irradiation target, the control circuit reduces a speed at which the light irradiation circuit is rotated.

7. An optical sensing method comprising:
rotating a light irradiation circuit configured to irradiate an irradiation target being at least a part of a target with laser light, and thus moving an incident position of the laser light on the irradiation target in a reciprocating manner between one end portion and another end portion of the irradiation target, via a center portion positioned between the one end portion and the another end portion of the irradiation target;
reducing a speed at which the light irradiation circuit is rotated when the incident position moves from the one end portion or the another end portion to the center portion of the irradiation target;
acquiring information relating to reflected light associated with the incident position, based on the reflected light of the laser light from the irradiation target; and
generating point cloud data relating to the irradiation target, based on the information relating to the reflected light.
